(19) United States
(12) Patent Application Publication
(10) Pub. No.: US 2024/0359092 A1
(43) Pub. Date: Oct. 31, 2024

(54) SYSTEM, INFORMATION PROCESSING APPARATUS, PROCESSING METHOD, AND NON-TRANSITORY COMPUTER-READABLE STORAGE MEDIUM

(71) Applicant: Nintendo Co., Ltd., Kyoto-shi (JP)

(72) Inventors: Mitsuru KATAYAMA, Kyoto-shi (JP); Hiroyuki TAKEUCHI, Kyoto-shi (JP); Keisuke SEKO, Kyoto-shi (JP); Yoshitaka NAKANO, Kyoto-shi (JP); Yuta FUJITA, Kyoto-shi (JP); Tatsuya AJIMIZU, Kyoto-shi (JP)

(21) Appl. No.: 18/764,985

(22) Filed: Jul. 5, 2024

Related U.S. Application Data
(63) Continuation of application No. PCT/JP2022/006691, filed on Feb. 18, 2022.

(51) Int. Cl. A63F 13/428; A63F 13/211; A63F 13/25

(52) U.S. Cl. CPC A63F 13/428; A63F 13/211; A63F 13/25

(57) ABSTRACT

A system includes a display, one or more processors, and one or more memories to store instructions that, when executed by the one or more processors, cause the one or more processors to perform obtaining a direction in which a controller is present with respect to the display, showing on the display, an image including a first object and a second object, the first object being moved in accordance with a user input to the controller without being moved in accordance with the obtained direction, the second object presenting information on at least one of a user who operates the controller and/or the first object, and changing at least one of a display position and/or an orientation of the second object in accordance with the obtained direction.

This nonprovisional application claims priority on and is a continuation of International Patent Application PCT/JP2022/006691 filed with the Japan Patent Office on Feb. 18, 2022, the entire contents of which are hereby incorporated by reference.

### FIELD

The present disclosure relates to a system, an information processing apparatus, a processing method, and a non-transitory computer-readable storage medium.

### BACKGROUND AND SUMMARY

An information processing apparatus that shows a menu screen or a screen involved with a game has conventionally been known.

It would be desirable to improve viewability of a shown image and/or operability of a controller as compared with the known apparatus described above.

An exemplary embodiment provides a system that includes a display, and one or more memories configured to store instructions. The instructions, when executed, cause one or more processors to perform operations comprising obtaining a direction in which a controller is present with respect to the display (or, in other words, obtaining a direction of the controller relative to the display); showing on the display an image including a first object and a second object, the first object being movable within the image in accordance with user input to the controller, the second object presenting information about a user who operates the controller and/or the first object; and responsive to the direction in which the controller is present with respect to the display moving from a first direction to a second direction, changing a display position and/or an orientation of the second object in accordance with move from the first direction to the second direction, without also moving the first object in the image.

According to this configuration, the second object is shown at the display position and/or in the orientation in accordance with the direction in which the controller (and the user who operates the controller) is present with respect to the display, and hence viewability of the second object from the user can be improved. Furthermore, since the user can operate the controller while the user is viewing the second object shown at the display position and/or in the orientation in accordance with the direction in which the controller (and the user who operates the controller) is present with respect to the display, operability of the controller by the user can be improved. That is, in certain example embodiments, it becomes possible to provide improvements to human-computer interaction, for example, by increasing viewability/understandability of elements within images, by providing an adaptive and more intuitive control system, etc.

Responsive to the detected change to the direction in which the controller is present with respect to the display, a correspondence between the user input to the controller and an aspect of an operation applicable to the first object may be changed. According to this configuration, since an aspect of the operation applicable to the first object corresponding to the user input to the controller is changed in accordance with the direction in which the controller (and the user who operates the controller) is present with respect to the display, operability of the controller by the user can be improved.

The controller may include a direction input portion. The correspondence that is changed may be a correspondence between a direction inputted to the direction input portion and a direction of movement of the first object on the display. According to this configuration, since an aspect of the operation applicable to the first object is changed in accordance with the direction in which the controller (and the user who operates the controller) is present with respect to the display even when the user input to the direction input portion is the same, operability of the controller by the user can be improved.

The controller may include a sensor configured to detect motion of the controller. The correspondence that is changed may be the correspondence between a direction of the detected motion and a direction of movement of the first object on the display. According to this configuration, since an aspect of the operation applicable to the first object are changed in accordance with the direction in which the controller (and the user who operates the controller) is present with respect to the display even when the user input provides the same motion to the controller, operability of the controller by the user can be improved.

The display may be rectangular. The correspondence may be maintained so long as the controller is determined to be present in an area corresponding to one side of the display, and the correspondence may be changed when the controller is determined to be present in another area corresponding to another side of the display. According to this configuration, by maintaining and changing the correspondence in correspondence with each side of the rectangular display, recognition by the user can further be clarified and operability of the controller by the user can be improved.

The correspondence may be changed after the changing of the display position and/or the orientation of the second object. According to this configuration, as a result of change in display position or orientation of the second object, the user can recognize that the system has detected change in direction in which the controller (and the user who operates the controller) is present with respect to the display. Since the correspondence is then changed, a possibility of an uncomfortable or disoriented feeling felt when the user operates the controller can be lowered.

A display position of the second object may be selected from among a plurality of predefined display positions for the second object in accordance with the direction after the detected change. According to this configuration, the second object is shown at any one of the plurality of predetermined positions. Therefore, even when the controller (and the user who operates the controller) moves, the possibility of a fluctuation of the display position of the second object can be reduced. For instance, a situation in which a slight movement (made either intentionally or inadvertently, e.g., for less than a certain amount of time) will not cause a corresponding change in the movement of the second object in certain example embodiments. The possibility of decreased viewability from the user can be suppressed.

Each of a plurality of second objects may be associated with a respective user using the system, each display position for each second objects being selected from the plurality of predefined display positions in accordance with a direction of a controller of the associated user. According to this configuration, the display position of the second object can be determined in accordance with relative positional relation between/among controllers or an order of arrangement of the controllers. Therefore, even when a display space is limited, an uncomfortable or disoriented feeling felt by the user can be suppressed.

When the selected display position of the second object is different from a current display position of the second object, the display position of the second object may be changed from the current display position to the selected display position after a condition is satisfied. According to this configuration, even when the controller (and the user who operates the controller) frequently moves, a frequent change in display position of the second object can be suppressed. An uncomfortable or disoriented feeling that otherwise might be felt by the user can thus be suppressed.

The condition may be satisfied when a predetermined time period elapses. According to this configuration, whether or not the predetermined condition has been satisfied can be determined by counting time.

When second objects are shown for three or more users, display positions of the second objects may be rearrangeable from current positions to newly selected positions in accordance with the obtained directions such that second objects adjacent to one in their current positions will not necessarily be adjacent to one another in their newly selected positions. According to this configuration, representation of the second object on which the order of arrangement of the controller (and the user who operates the controller) is reflected can be realized.

In addition to not being moved in accordance with the obtained direction, the first object does not have to be changed in orientation either. In other words, the first object does not necessarily change orientation based on the detected change to the direction in which the controller is present with respect to the display. According to this configuration, when a plurality of users play a game or an application while they view the display, the display position and the orientation of the first object are maintained in spite of movement of the controller (and the user who operates the controller). Therefore, while an uncomfortable or disoriented feeling felt by the user is lessened, operability of the controller can be maintained.

Another exemplary embodiment provides a processing method that includes obtaining (e.g., measuring) a direction in which a controller is present with respect to a display; showing on the display an image including a first object and a second object, the first object being movable within the image in accordance with user input to the controller, the second object presenting information about a user who operates the controller and/or the first object; and responsive to the direction in which the controller is present with respect to the display moving from a first direction to a second direction, changing a display position and/or an orientation of the second object in accordance with the move from the first direction to the second direction, without also moving the first object in the image.

Another exemplary embodiment provides a non-transitory computer-readable storage medium having instructions stored thereon which, when executed, cause one or more processors to perform operations comprising: obtaining (e.g., measuring) a direction in which a controller is present with respect to a display; showing on the display an image including a first object and a second object, the first object being movable within the image in accordance with user input to the controller, the second object presenting information about a user who operates the controller and/or the first object; and responsive to the direction in which the controller is present with respect to the display moving from a first direction to a second direction, changing a display position and/or an orientation of the second object in accordance with the move from the first direction to the second direction, without also moving the first object in the image.

The foregoing and other features, aspects, and advantages of the present disclosure will become more apparent from the following detailed description when taken in conjunction with the accompanying drawings.

### BRIEF DESCRIPTION OF THE DRAWINGS

FIG. 1 shows an exemplary illustrative non-limiting drawing illustrating an exemplary configuration of a system according to the present embodiment.

FIG. 2 shows an exemplary illustrative non-limiting drawing illustrating an exemplary hardware configuration of a game device in the system according to the present embodiment.

FIG. 3 shows an exemplary illustrative non-limiting drawing illustrating an exemplary hardware configuration of a controller in the system according to the present embodiment.

FIG. 4 shows an exemplary illustrative non-limiting drawing illustrating principles of direction measurement in the system according to the present embodiment.

FIG. 5 shows an exemplary illustrative non-limiting drawing illustrating an exemplary antenna module in which a plurality of antenna elements are arranged in one direction.

FIG. 6 shows an exemplary illustrative non-limiting drawing illustrating an exemplary antenna module in which a plurality of antenna elements are arranged in two directions.

FIG. 7 shows an exemplary illustrative non-limiting drawing illustrating an exemplary configuration of a short-range communication unit in the system according to the present embodiment.

FIG. 8 shows an exemplary illustrative non-limiting drawing illustrating an exemplary configuration of a frame transmitted by the controller in the system according to the present embodiment.

FIGS. 9A and 9B show exemplary illustrative non-limiting drawings illustrating an exemplary screen outputted by the game device in the system according to the present embodiment.

FIG. 10 shows an exemplary illustrative non-limiting drawing illustrating another exemplary screen outputted by the game device in the system according to the present embodiment.

FIGS. 11 and 12 show exemplary illustrative non-limiting drawings illustrating exemplary correspondence between a user input to the controller and an operational aspect of an operation in the exemplary screen shown in FIG. 10.

FIGS. 13A and 13B show exemplary illustrative non-limiting drawings illustrating other exemplary correspondence between a user input to the controller and an operational aspect of an operation in the exemplary screen shown in FIG. 10.

FIG. 14 shows an exemplary illustrative non-limiting drawing illustrating an exemplary user operation definition in the game device in the system according to the present embodiment.

FIG. 15 shows an exemplary illustrative non-limiting drawing illustrating exemplary processing for selecting the user operation definition in the game device in the system according to the present embodiment.

FIG. 16 shows an exemplary illustrative non-limiting drawing illustrating an exemplary screen on which information presentation objects are shown at a plurality of predetermined positions in the system according to the present embodiment.

FIGS. 17A to 17C show exemplary illustrative non-limiting drawings illustrating exemplary processing for changing representation of the information presentation object in the system according to the present embodiment.

FIG. 18 shows an exemplary illustrative non-limiting drawing illustrating a plurality of exemplary predetermined positions at which information presentation objects are to be shown in the system according to the present embodiment.

FIG. 19 shows an exemplary illustrative non-limiting drawing illustrating a flowchart showing a procedure of processing performed by the game device in the system according to the present embodiment.

FIG. 20 shows an exemplary illustrative non-limiting drawing illustrating a flowchart showing a procedure of processing in direction measurement shown in FIG. 19.

### DETAILED DESCRIPTION OF NON-LIMITING EXAMPLE EMBODIMENTS

The present embodiment will be described in detail with reference to the drawings. The same or corresponding elements in the drawings have the same reference characters allotted and description thereof will not be repeated.

### [A. Exemplary Configuration]

An exemplary configuration of a system 1 according to the present embodiment will initially be described.

Though a game device will be described by way of example of an information processing apparatus in the description below, the information processing apparatus is not limited to the game device, and any computer such as a smartphone, a tablet, and a personal computer can be adopted. The information processing apparatus is not limited to a portable apparatus and it may be a stationary apparatus.

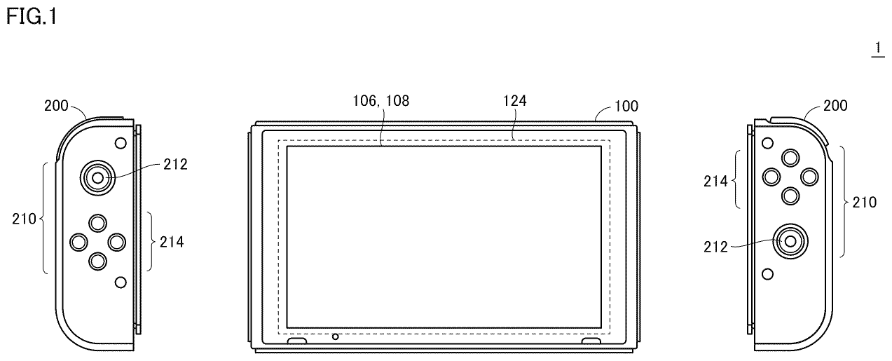

An exemplary configuration of system 1 according to the present embodiment will be described with reference to FIG. 1. System 1 includes a game device 100 and one or more controllers 200.

The “controller” herein is a term encompassing a device that receives a user input, and encompasses, for example, a general-purpose input device such as a keyboard, a mouse, and a pen tablet and an operation apparatus used for a specific application, without being limited to a game controller.

Game device 100 exchanges data with each of controllers 200 over a wireless signal. In other words, controller 200 transmits the wireless signal in accordance with a user input.

Controller 200 may be attachable to game device 100. In the present embodiment, controller 200 is attached to each of opposing sides of game device 100. While controller 200 is attached to game device 100, game device 100 may electrically be connected to controller 200. At this time, data may be exchanged through wired communication. Even while controller 200 is attached to game device 100, data may be exchanged through wireless communication.

Though a difference in structure and function between controllers 200 is not mentioned for the sake of convenience of description, the structure and the function of controller 200 may be different depending on a side (left side/right side) of attachment to game device 100.

Game device 100 includes a display 106 on which an image is shown and a touch panel 108 that receives a user input.

Game device 100 includes an antenna module 124 that receives a wireless signal from controller 200. Though antenna module 124 may be arranged at any position in game device 100, it is arranged, for example, in parallel to a display surface of display 106.

Each controller 200 includes an operation portion 210 that receives a user input. Operation portion 210 is composed, for example, of a push button, a cross-shaped key, and a control lever. In the example shown in FIG. 1, operation portion 210 includes a direction input portion 212 and an operation button 214.

Direction input portion 212 is implemented by an analog stick by way of example. In another embodiment, direction input portion 212 may be implemented by a slide pad, a touch pad, a cross-shaped key, or four buttons corresponding to respective directions. In yet another embodiment, direction input portion 212 may be implemented by an optical sensor such as an optical sensor in a mouse or an optical sensor in a pen-type controller. In still another embodiment, direction input portion 212 may be implemented by a camera or a subject imaged by the camera, and may recognize a direction input by image recognition of the subject imaged by the camera.

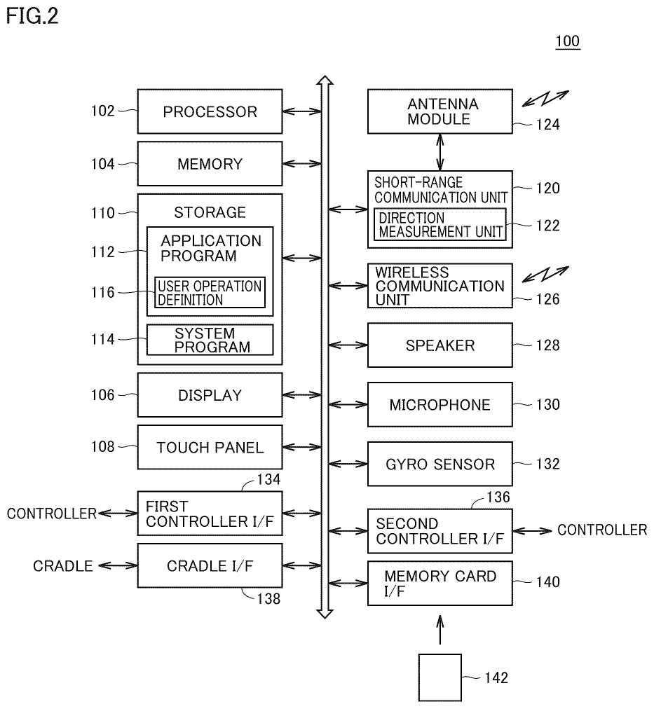

An exemplary hardware configuration of game device 100 in system 1 according to the present embodiment will be described with reference to FIG. 2. Game device 100 includes one or more processors 102, one or more memories 104, display 106, touch panel 108, a storage 110, a short-range communication unit 120, antenna module 124, a wireless communication unit 126, a speaker 128, a microphone 130, a gyro sensor 132, a first controller interface 134, a second controller interface 136, a cradle interface 138, and a memory card interface 140.

Processor 102 is a processing entity for performing processing provided by game device 100. Memory 104 is a storage device that can be accessed by processor 102, and it is implemented, for example, by a volatile storage device such as a dynamic random access memory (DRAM) or a static random access memory (SRAM). Storage 110 is implemented, for example, by a non-volatile storage device such as a flash memory.

Processor 102 performs processing as will be described later by reading instructions stored in storage 110, developing the instructions on memory 104, and executing the instructions. For example, an application program 112 composed of instructions for implementing an information processing and a system program 114 that provides a library necessary for execution of a program are stored in storage 110.

Processor 102 performs processing necessary in game device 100. Attention is paid in particular to processing for generating an image to be shown on the display or to be outputted to the display among such processing. In other words, processor 102 corresponds to a processing unit that has an image shown on display 106.

Application program 112 includes a user operation definition 116 that defines correspondence between a user input to controller 200 and an aspect of an operation applicable to an operation object as will be described later. User operation definition 116 includes a plurality of types of correspondence.

Short-range communication unit 120 transmits and receives a wireless signal to and from one or more controllers 200. Any wireless scheme such as Bluetooth®, ZigBee®, wireless LAN (IEEE 802.11), or infrared communication can be adopted for short-range communication unit 120. An example in which Bluetooth® is adopted as the wireless scheme for short-range communication unit 120 is shown in the description below.

Antenna module 124 receives a wireless signal transmitted from one or more controllers 200. Antenna module 124 may be arranged as an antenna for transmission and reception of a wireless signal by short-range communication unit 120, or antenna module 124 may be arranged in addition to a normal antenna for transmission and reception of a wireless signal by short-range communication unit 120.

Short-range communication unit 120 includes a direction measurement unit 122 that measures a direction in which controller 200 is present with respect to display 106 (that is, a direction in which controller 200 is present when viewed from game device 100). More specifically, direction measurement unit 122 measures based on a wireless signal from controller 200 received by antenna module 124, the direction in which controller 200 that has transmitted the wireless signal is present. A function provided by direction measurement unit 122 may be provided by short-range communication unit 120 or by coordination between short-range communication unit 120 and processor 102. Details of measurement processing by direction measurement unit 122 will be described later.

Wireless communication unit 126 exchanges over a wireless signal, data with a wireless relay connected to the Internet or the like. Any wireless scheme such as wireless LAN (IEEE802.11) and a public wireless channel (4G, 5G, or the like) can be adopted for wireless communication unit 126.

Speaker 128 generates a sound around game device 100. Microphone 130 collects sound generated around game device 100.

Gyro sensor 132 detects an attitude of game device 100.

While controller 200 is attached to game device 100, first controller interface 134 and second controller interface 136 exchange data with attached controller 200.

While game device 100 is placed on a cradle (not shown), cradle interface 138 exchanges data with the cradle.

Memory card interface 140 reads from a removable memory card 142, data stored in memory card 142 and writes data into memory card 142. An application program or the like may be stored in memory card 142.

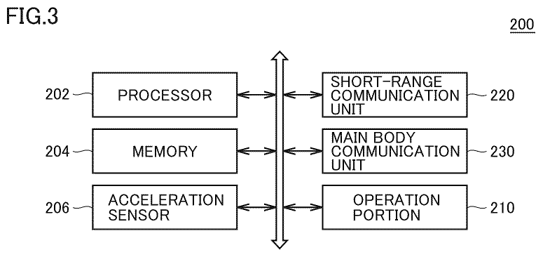

An exemplary hardware configuration of controller 200 in system 1 according to the present embodiment will be described with reference to FIG. 3. Controller 200 includes one or more processors 202, one or more memories 204, an operation portion 210, an acceleration sensor 206, a short-range communication unit 220, and a main body communication unit 230.

Processor 202 performs processing necessary for controller 200 by developing a program on memory 204 and executing the program.

Operation portion 210 generates a signal in accordance with a user input. Acceleration sensor 206 is a sensor that detects a motion of controller 200 and generates a signal in accordance with an acceleration caused in controller 200.

Short-range communication unit 220 transmits and receives a wireless signal to and from game device 100.

While controller 200 is attached to game device 100, main body communication unit 230 exchanges data with game device 100.

The term “processor” herein encompasses processing circuitry that performs processing in accordance with instructions described in a program, such as a central processing unit (CPU), a micro processing unit (MPU), or a graphics processing unit (GPU) and hard-wired circuitry where instructions are formed, such as an application specific integrated circuit (ASIC) or a field programmable gate array (FPGA). In the hard-wired circuitry such as an ASIC or an FPGA, a circuit corresponding to processing to be executed is formed in advance. Furthermore, the “processor” herein also encompasses circuitry in which a plurality of functions are integrated, such as a system on chip (SoC) and combination of the processing circuitry and the hard-wired circuitry.

The term “memory” herein encompasses a memory and a storage.

### [B. Direction Measurement]

Direction measurement that can be conducted by system 1 according to the present embodiment will now be described.

In system 1 according to the present embodiment, game device 100 performs a function to measure a direction in which controller 200 is present based on a wireless signal received from controller 200. More specifically, game device 100 calculates the direction in which controller 200 is present based on a phase difference caused at the time of reception of the wireless signal by a plurality of antenna elements arranged at distant positions.

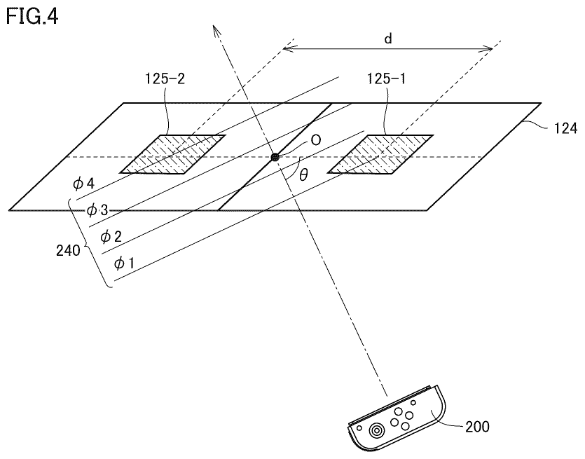

Principles of direction measurement by system 1 according to the present embodiment will be described with reference to FIG. 4. Antenna module 124 includes a plurality of antenna elements 125-1 and 125-2 (which may also collectively be referred to as an “antenna element 125” below).

Since a distance between game device 100 and controller 200 is sufficiently longer than a wavelength of the wireless signal, the wireless signal transmitted from controller 200 can be regarded as a plane wave. Therefore, an equiphase plane 240 of the wireless signal transmitted from controller 200 is orthogonal to a straight line that connects controller 200 and a center O between antenna element 125-1 and antenna element 125-2 to each other (a straight line at an angle θ with respect to the straight line that connects antenna element 125-1 and antenna element 125-2 to each other.). Angle θ represents an angle of incidence of the wireless signal on antenna module 124 and is also referred to as an angle of arrival.

In the example shown in FIG. 4, antenna element 125-1 intersects with equiphase plane 240 at a phase φ1 and antenna element 125-2 intersects with equiphase plane 240 at a phase φ4. In other words, a phase difference Δφ by |phase φ1−phase φ4| is caused between the wireless signal received by antenna element 125-1 and the wireless signal received by antenna element 125-2. This phase difference Δφ is dependent on angle θ and a distance d between elements.

More specifically, a relational expression as below is satisfied where k represents a wavelength of the wireless signal.

$$Δ ϕ = 2 π \times ( d \times cos ( θ ) / λ )$$

This relational expression can be summarized with respect to angle θ (angle of arrival) to an expression as below.

$$θ = {cos}^{- 1} ( ( Δ ϕ \times λ ) / ( 2 π \times d ) )$$

Since wavelength k of the wireless signal and distance d between the elements have already been known, the direction (angle θ) in which controller 200 is present can be calculated based on phase difference Δφ caused in the wireless signal received by two antenna elements 125.

Though antenna module 124 should only include at least two antenna elements 125, measurement accuracy can be enhanced by including more antenna elements 125.

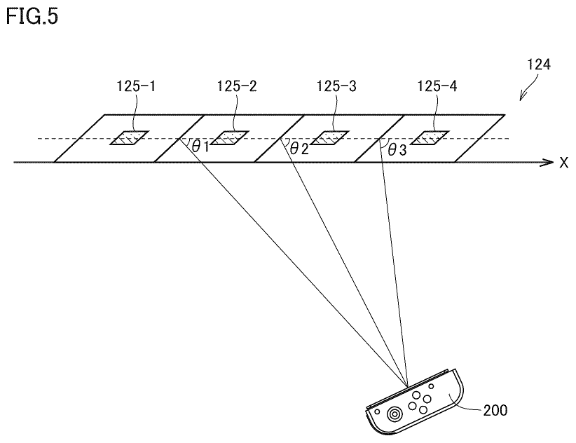

Exemplary antenna module 124 in which a plurality of antenna elements 125 are arranged in one direction will be described with reference to FIG. 5. Antenna module 124 shown in FIG. 5 includes four antenna elements 125-1 to 125-4 arranged in one row along an X axis. In such arrangement of antenna elements 125, an (a one-dimensional) angle of arrival with respect to the X axis can be measured. More specifically, two antenna modules 124 can be used to measure the angle of arrival of the wireless signal transmitted from controller 200 when viewed from the center between two antenna modules 124. Any two adjacent antenna elements 125 may be selected, or two adjacent antenna elements 125 may successively be selected. Alternatively, in another embodiment, any two antenna elements which are not adjacent to each other may be selected.

In the example shown in FIG. 5, an angle θ1 can be measured by selection of antenna element 125-1 and antenna element 125-2, an angle θ2 can be measured by selection of antenna element 125-2 and antenna element 125-3, and an angle θ3 can be measured by selection of antenna element 125-3 and antenna element 125-4.

In addition to the direction of controller 200 that has transmitted the wireless signal at the measured angle, a position (or a distance) of controller 200 can be measured. The direction and the position to be measured are each expressed as a value relative to display 106. Therefore, processing for measuring the “direction” herein may encompass processing for measuring the “position”.

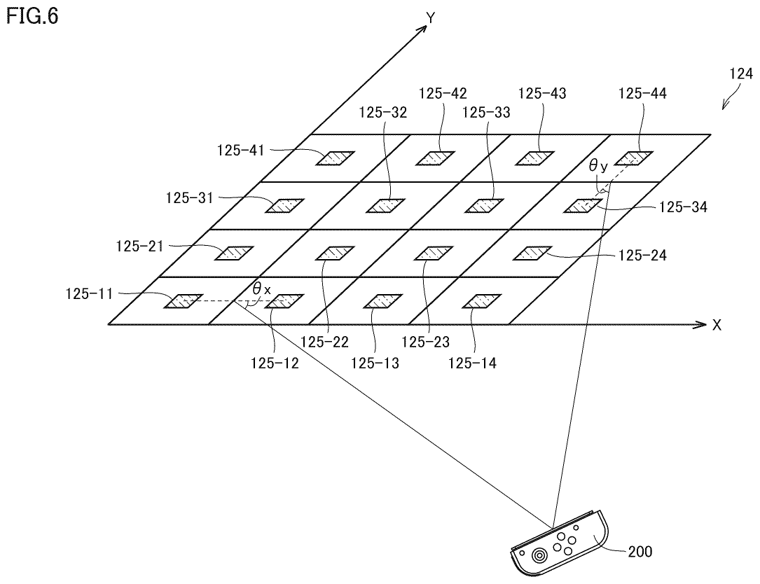

Exemplary antenna module 124 in which a plurality of antenna elements 125 are arranged in two directions will be described with reference to FIG. 6. Antenna module 124 shown in FIG. 6 includes 4×4 antenna elements 125-11 to 125-44 arranged along the X axis and a Y axis. In such arrangement of antenna elements 125, an (a two-dimensional) angle of arrival with respect to each of the X axis and the Y axis can be measured.

More specifically, two antenna modules 124 arranged in the same row along the X axis can be used to measure a component with respect to the X axis, of the angle of arrival of the wireless signal transmitted from controller 200. Similarly, two antenna modules 124 arranged in the same row along the Y axis can be used to measure a component with respect to the Y axis, of the angle of arrival of the wireless signal transmitted from controller 200.

In the example shown in FIG. 6, an angle Ox which is a component of the angle of arrival with respect to the X axis can be measured by selecting antenna element 125-11 and antenna element 125-12, and an angle Oy which is a component of the angle of arrival with respect to the Y axis can be measured by selecting antenna element 125-34 and antenna element 125-44.

In addition to the direction of controller 200, a position (or a distance) of controller 200 can be measured by conducting measurement a plurality of times with combination of antenna elements 125 being varied as in FIG. 5.

In direction measurement as described above, a plurality of antenna elements 125 should receive the same wireless signal. Though a plurality of reception circuits may be prepared, antenna element 125 to be used for reception among the plurality of antenna elements 125 may successively be switched for a common reception circuit.

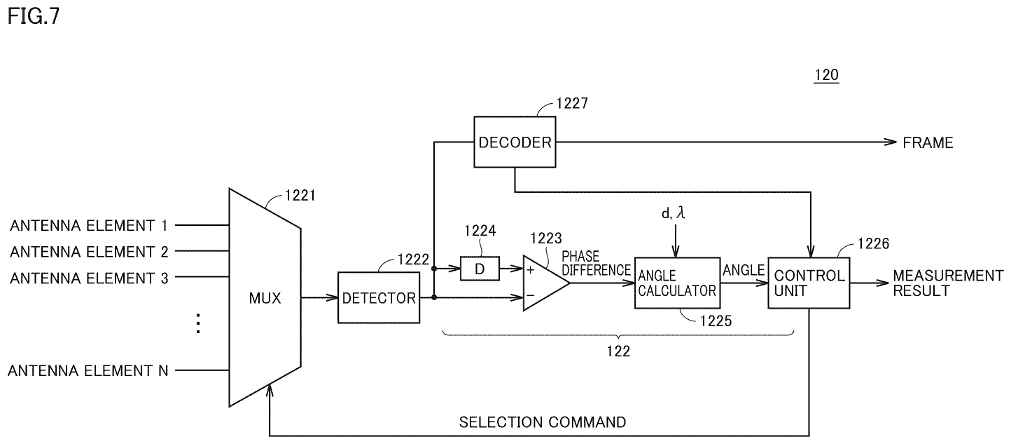

An exemplary configuration of short-range communication unit 120 in system 1 according to the present embodiment will be described with reference to FIG. 7. FIG. 7 shows an example in which direction measurement unit 122 is mounted as a part of the configuration of short-range communication unit 120.

Short-range communication unit 120 includes a multiplexer 1221, a detector 1222, a subtractor 1223, a delay element 1224, an angle calculator 1225, a control unit 1226, and a decoder 1227. Direction measurement unit 122 is mainly composed of subtractor 1223, delay element 1224, angle calculator 1225, and control unit 1226.

Multiplexer 1221 selects one antenna element 125 from among the plurality of antenna elements 125 in accordance with a selection command from control unit 1226.

Detector 1222 decodes a wireless signal received by antenna element 125 connected with multiplexer 1221 being interposed and outputs the decoded signal.

Subtractor 1223 calculates a phase difference between signals outputted from detector 1222. A signal outputted from detector 1222 is directly inputted to one terminal of subtractor 1223 and a signal outputted from detector 1222 is inputted to the other terminal of subtractor 1223 via delay element 1224. Time of delay by delay element 1224 is set in accordance with time of selection by multiplexer 1221. In other words, subtractor 1223 receives input of the signal obtained by decoding of the wireless signal received by currently selected antenna element 125 and the signal obtained by decoding of the wireless signal received by immediately precedently selected antenna element 125.

Angle calculator 1225 calculates an angle (angle of arrival) from the phase difference calculated by subtractor 1223. Distance d between the elements and wavelength λ are set in advance in angle calculator 1225.

Control unit 1226 outputs a selection command to multiplexer 1221 and outputs a measurement result indicating a direction in which controller 200 is present by performing statistic processing (for example, averaging processing or outlier exclusion processing) on angles calculated successively by angle calculator 1225 in accordance with the selection command. The measurement result may include a distance to controller 200 in addition to a one-dimensional angle or a two-dimensional angle indicating the direction in which controller 200 is present.

Decoder 1227 reconstructs a frame from the signal outputted from detector 1222. Decoder 1227 outputs identification information for identifying a sender of the wireless signal to control unit 1226 based on information included in the frame.

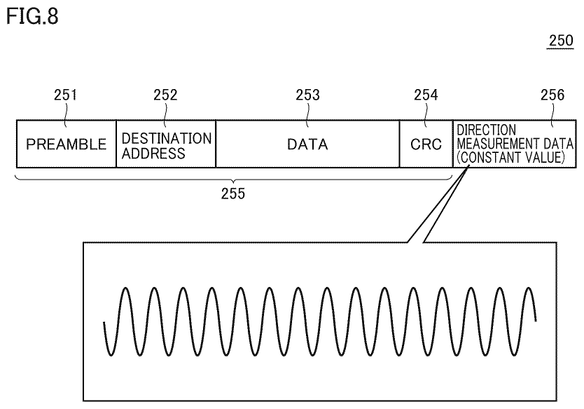

An exemplary configuration of a frame transmitted by controller 200 in system 1 according to the present embodiment will be described with reference to FIG. 8.

A frame 250 includes a header 251, a destination address 252, data 253, a CRC 254, and direction measurement data 256. Header 251, destination address 252, data 253, and CRC 254 correspond to a substantial frame 255.

Direction measurement data 256 includes a plurality of constant values (normally “1”). Since the value included in direction measurement data 256 does not vary over time, the wireless signal is a sinusoidal wave, a phase and an amplitude of which do not vary over time. Direction measurement as described above is conducted with the use of this sinusoidal wave.

Destination address 252 includes identification information for identifying controller 200 that has transmitted the wireless signal. Therefore, in an example where a plurality of controllers 200 are connected to game device 100, the direction can be measured for each controller 200. Specifically, from which controller 200 the wireless signal comes is identified based on information included in destination address 252, and then the direction in which identified controller 200 is present is measured.

### [C. Exemplary Screen Representation Using Measurement Result in Direction Measurement]

Some exemplary screen representations using measurement results in direction measurement described above will now be described.

In system 1 according to the present embodiment, game device 100 can generate an image based on a direction in which controller 200 is present with respect to display 106.

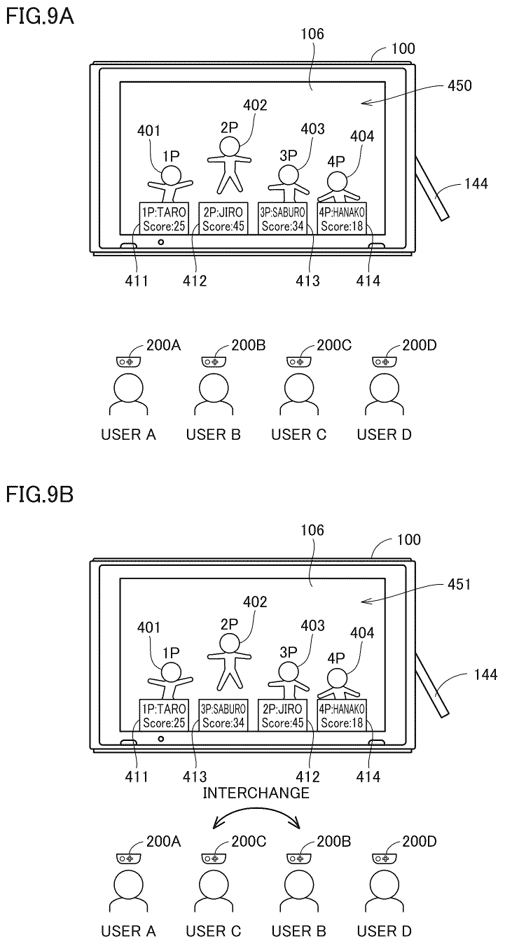

An exemplary screen outputted by game device 100 in system 1 according to the present embodiment will be described with reference to FIGS. 9A and 9B. FIGS. 9A and 9B show an example in which one or more users operate controller(s) 200 while viewing the image shown on display 106, with game device 100 being supported and placed on a stand 144 such that display 106 is laterally oriented or oriented obliquely upward. A form of use as shown in FIGS. 9A and 9B may also be referred to as a “standing mode” below.

Referring to FIG. 9A, an image 450 shown on display 106 of game device 100 includes operation objects 401 to 404 moved in accordance with a user input to controller 200. Specifically, a user A uses a controller 200A to operate operation object 401, a user B uses a controller 200B to operate operation object 402, a user C uses controller 200C to operate operation object 403, and a user D uses a controller 200D to operate operation object 404.

Image 450 further includes information presentation objects 411 to 414 that present information on at least one of the user and/or the operation object. In the example shown in FIGS. 9A and 9B, information presentation objects 411 to 414 include player names and scores of operation objects 401 to 404 operated by corresponding users, respectively.

Game device 100 (processor 102) thus shows on display 106, an image including the operation object and the information presentation object.

The “operation object” herein corresponds to the first object and means an object operated in accordance with a user input to controller 200 (or touch panel 108 or the like). The operation object may in some instances be a player character. Though the operation object is moved in accordance with the user input to controller 200, it is not moved in accordance with the measured direction. The operation object may be or may not be changed in display position and/or orientation in accordance with the measured direction. In addition to not being moved in accordance with the measured direction, the operation object may thus also be prevented from being changed in orientation.

The “information presentation object” herein corresponds to the second object and means an object that presents information, e.g., on at least one of the user who operates controller 200 and/or the operation object. Specifically, the information presentation object encompasses an object for providing necessary information to the user when game device 100 proceeds with an application. The information presentation object includes, for example, a user name, a player name allocated to the user, an arrow indicating a direction in which controller 200 (or the user who operates controller 200) is present, and a state value (for example, a physical power value or an empirical value) of the operation object. The information presentation object can thus also be regarded as an object for simply providing information, rather than an object that affects progress of a running game or application.

The display position and/or the orientation of the information presentation object are/is not changed in accordance with the user input. In another embodiment, however, the display position and/or the orientation of the information presentation object may be changed in accordance with the user input. Change in display position and/or orientation in accordance with the user input encompasses change in display position and/or orientation of the information presentation object with change in display position and/or orientation of the operation object in accordance with the user input because of association of the display position and/or the orientation of the information presentation object with the operation object and change in display position and/or orientation of the information presentation object independent of the operation object. The former case includes, for example, an arrow indicating the operation object operated by the user, the arrow being shown at a predetermined display position and/or in a predetermined orientation with respect to the operation object.

Though the image shown on display 106 may include the operation object and the information presentation object in the present embodiment, the display position and/or the orientation of the information presentation object are/is changed in accordance with the measured direction.

In the example shown in FIG. 9A, display positions of information presentation objects 411 to 414 are as seen in image 450 on which the direction in which the users A to D (controllers 200A to 200D) are present with respect to display 106 is reflected. Specifically, from the left as facing display 106, controller 200A, controller 200B, controller 200C, and controller 200D are present in this order, and in correspondence with this positional relation, information presentation object 411, information presentation object 412, information presentation object 413, and information presentation object 414 are shown on display 106 sequentially from the left.

FIG. 9B shows a state in which the user B and the user C have interchanged in their positions by way of example. Since directions in which controller 200B and controller 200C are present consequently change, game device 100 shows an image 451 on display 106 where the display positions of information presentation object 412 and information presentation object 413 having been changed.

Game device 100 thus changes the display position of the information presentation object in accordance with the measured direction in which controller 200 is present.

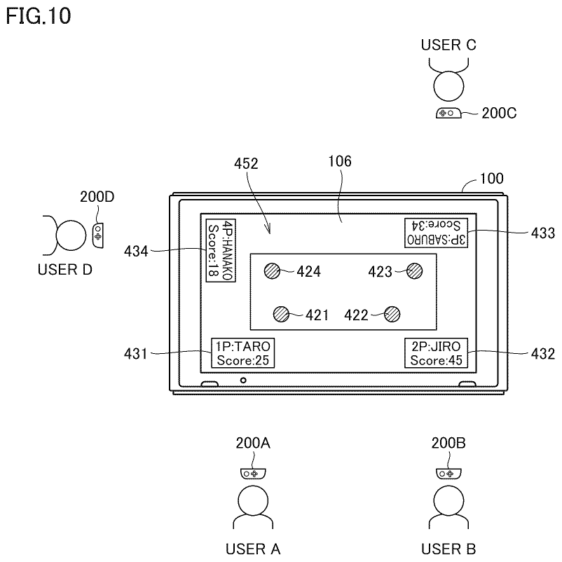

Another exemplary screen outputted by game device 100 in system 1 according to the present embodiment will be described with reference to FIG. 10. FIG. 10 shows an example in which one or more users operate controller(s) 200 while the one or more users view an image shown on display 106 with display 106 being placed as being facing up. A form of use as shown in FIG. 10 may also be referred to as a “lay-flat mode” below.

In the form of use as shown in FIG. 10, the user is present around display 106. A case in which the users A to D are present around display 106 and each user operates controller 200 to play a game is assumed in the example shown in FIG. 10.

An image 452 shown on display 106 of game device 100 includes operation objects 421 to 424 operated in accordance with the user input to controller 200. Image 452 further includes information presentation objects 431 to 434 that present information on at least one of the user and/or the operation object. In the example shown in FIG. 10, information presentation objects 431 to 434 include player names allocated to corresponding users and scores of the corresponding users, respectively.

The display positions and the orientations of information presentation objects 431 to 434 are in accordance with the positions where the users A to D (controllers 200A to 200D) are present with respect to display 106.

More specifically, information presentation object 431 including information for the user A is arranged at the display position and in the orientation corresponding to the direction in which controller 200A is present. Similarly, information presentation object 432 including information for the user B is arranged at the display position and in the orientation corresponding to the direction in which controller 200B is present, information presentation object 433 including information for the user C is arranged at the display position and in the orientation corresponding to the direction in which controller 200C is present, and information presentation object 434 including information for the user D is arranged at the display position and in the orientation corresponding to the direction in which controller 200D is present.

The position and the orientation of a game screen itself as the entirety to be shown on display 106 are not changed in accordance with the direction in which controller 200 is present.

Game device 100 thus changes the display position and the orientation of the information presentation object in accordance with the measured direction in which controller 200 is present.

Though FIGS. 9A and 9B show the example in which the display position of the information presentation object is changed in accordance with the measured direction and FIG. 10 shows the example in which the display position and the orientation of the information presentation object are changed in accordance with the measured direction, only the orientation of the information presentation object may be changed (with the display position thereof being maintained) or only the display position of the information presentation object may be changed with the orientation thereof being maintained, in accordance with the measured direction.

Since the display position and/or the orientation of the information presentation object are/is thus changed in accordance with the measured direction in which controller 200 is present, viewability of the information presentation object also from the user who operates controller 200 can be improved. In addition, since the user operates controller 200 while the user refers to the information presentation object, operability can be improved.

[D. Change in Operational Aspect(s) in Accordance with Measurement Result in Direction Measurement]

Some examples of a change in an aspect of an operation applicable to the operation object corresponding to the user operation in accordance with a measurement result in direction measurement described above will now be described.

Game device 100 may change correspondence between the user input to controller 200 and an aspect of an operation applicable to the operation object in accordance with the measured direction. In other words, game device 100 may change interpretation of the user operation corresponding to the user input to controller 200 in accordance with the measured direction. More specifically, an operation onto the operation object corresponding to the same user operation onto controller 200 may be made different, with relative relation between the position where controller 200 (or the user who operates controller 200) is present and display 106 being reflected.

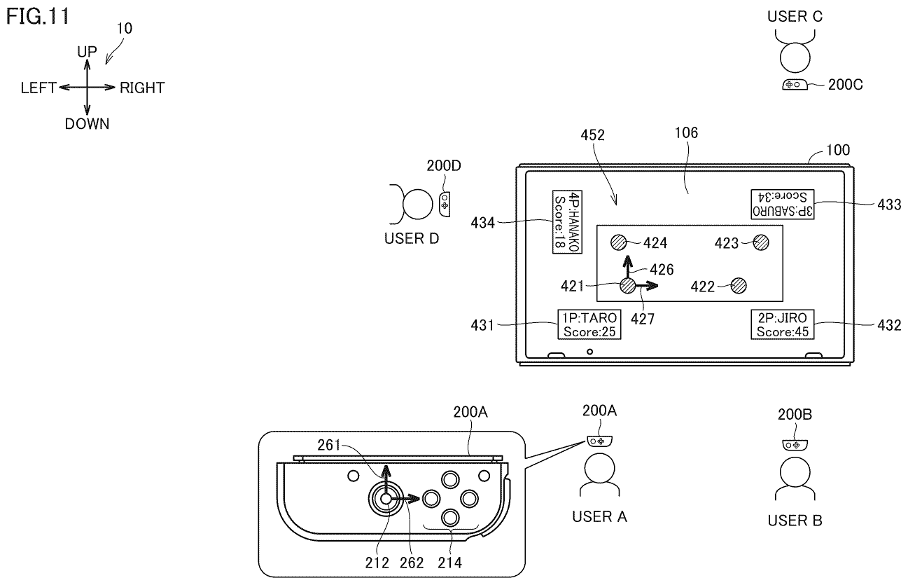

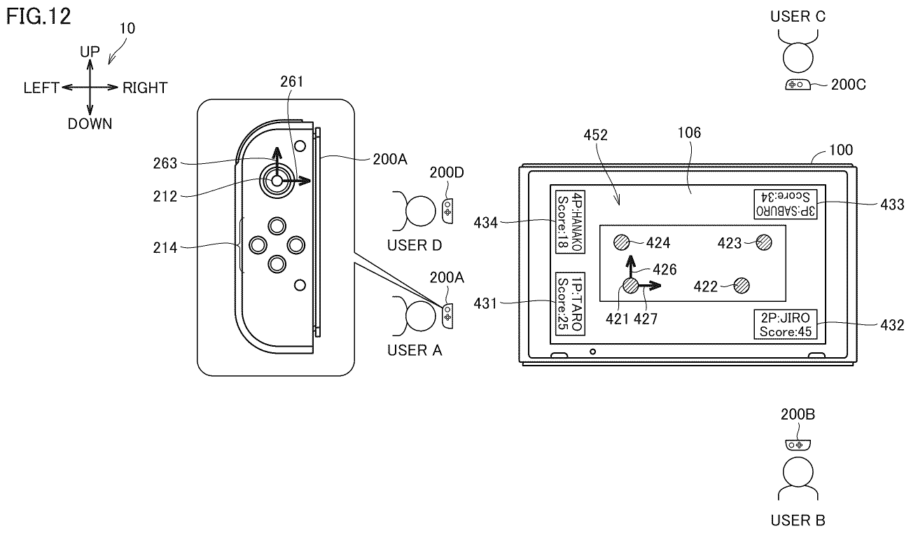

Exemplary correspondence between the user input to controller 200 and an aspect of an operation in the exemplary screen shown in FIG. 10 will be described with reference to FIGS. 11 and 12. Referring to FIG. 11, for example, operation object 421 included in image 452 is assumed as being operable from controller 200A.

In the example shown in FIG. 11, the user A who holds controller 200A is present in an area corresponding to a lower side (a “down” side indicated by a direction indicator 10) of display 106.

The user A laterally holds controller 200A. When the user A performs an input operation to press direction input portion 212 of controller 200A in an upward direction (an operation direction 261) in this state, game device 100 interprets this input operation as an operation to move operation object 421 in a direction 426. Alternatively, in the example shown in FIG. 11, in order to move operation object 421 in a direction 427, the user A should perform an input operation to press direction input portion 212 of controller 200A in a right direction (an operation direction 262).

An example in which the user A who holds controller 200A moves to an area corresponding to a left side (a “left” side indicated by direction indicator 10) of display 106 is assumed as shown in FIG. 12. The display position and the orientation of information presentation object 431 corresponding to the user A are changed with movement of the user A.

When the user A performs an input operation to press direction input portion 212 of controller 200A in the upward direction (operation direction 261) in this state, game device 100 interprets the input operation as an operation to move operation object 421 in direction 427 rather than direction 426. Alternatively, in the example shown in FIG. 12, in order to move operation object 421 in direction 426, the user A should perform an input operation to press direction input portion 212 of controller 200A in the left direction (an operation direction 263).

For the same user input to direction input portion 212 of controller 200, game device 100 thus determines a different operational aspect for the operation object. In other words, game device 100 changes correspondence between the direction inputted to direction input portion 212 and the direction of movement of the operation object in the screen.

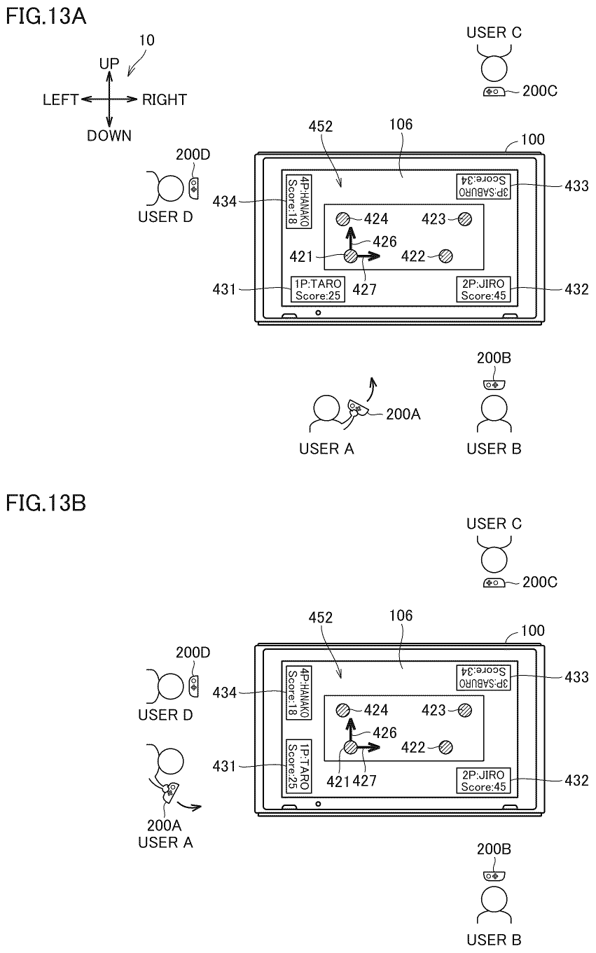

Other exemplary correspondence between the user input to controller 200 and an aspect of an operation in the exemplary screen shown in FIG. 10 will be described with reference to FIGS. 13A and 13B. Referring to FIGS. 13A and 13B, for example, operation object 421 included in image 452 is assumed as being operable from controller 200A.

In the example shown in FIG. 13A, the user A who holds controller 200A is present in the area corresponding to the lower side (the “down” side indicated by direction indicator 10) of display 106. When the user A performs an input operation to swing controller 200A forward, acceleration sensor 206 of controller 200A outputs a signal in accordance with the user input from the user A. Game device 100 then interprets the user input as an operation to move operation object 421 in direction 426.

On the other hand, an example in which the user A who holds controller 200A moves to the area corresponding to the left side (the “left” side indicated by direction indicator 10) of display 106 is assumed as shown in FIG. 13B. The display position and the orientation of information presentation object 431 corresponding to the user A are changed with movement of the user A.

When the user A performs an input operation to swing controller 200A forward in this state, acceleration sensor 206 of controller 200A outputs the signal in accordance with the user input from the user A. Game device 100 then interprets the user input as the operation to move operation object 421 in direction 427 rather than direction 426.

For the same user input to controller 200, game device 100 thus determines a different operational aspect for the operation object. In other words, game device 100 changes correspondence between the direction of the detected motion of controller 200 and the direction of movement of the operation object in the screen.

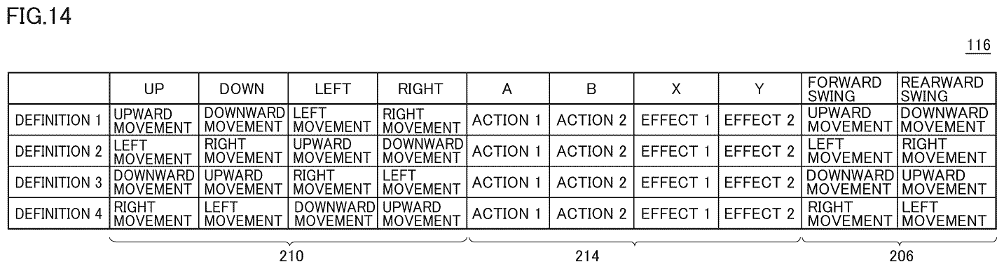

An exemplary user operation definition 116 in game device 100 in system 1 according to the present embodiment will be described with reference to FIG. 14. For example, four types of user operation definitions 116 may be prepared in accordance with respective sides of display 106. The definitions include aspects of operations applicable to the operation objects allocated to a plurality of directions (for example, the up direction, the down direction, the left direction, and the right direction) that can be inputted to direction input portion 212, aspects of operations applicable to the operation objects allocated to operation buttons 214 (for example, an A button, a B button, an X button, and a Y button), and aspects of operations applicable to the operation objects allocated to detection signals (for example, forward swing and rearward swing) from acceleration sensor 206.

Game device 100 selects any one of the plurality of definitions in accordance with the measured direction of controller 200.

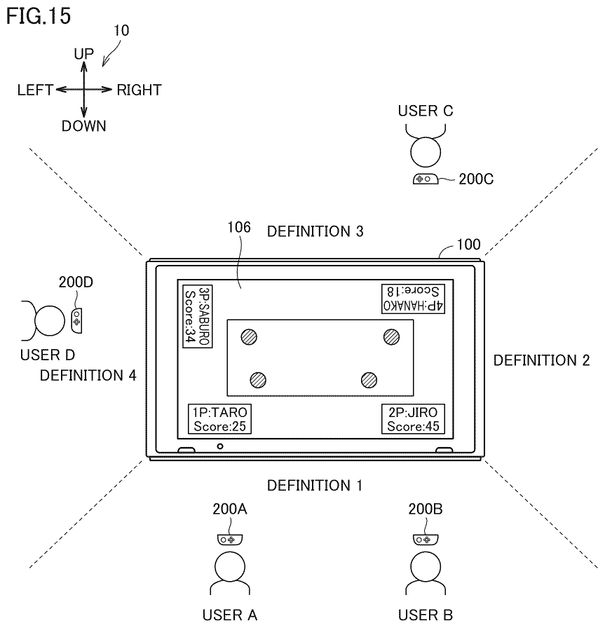

Exemplary processing for selecting user operation definition 116 in game device 100 in system 1 according to the present embodiment will be described with reference to FIG. 15. As shown in FIG. 15, definitions included in user operation definition 116 may be allocated in correspondence with the respective sides of rectangular display 106.

For example, when the user is present in the area corresponding to the lower side (the “down” side indicated by direction indicator 10) of display 106, a definition 1 may be selected, when the user is present in the area corresponding to the right side (a “right” side indicated by direction indicator 10) of display 106, a definition 2 may be selected, when the user is present in the area corresponding to the upper side (an “up” side indicated by direction indicator 10) of display 106, a definition 3 may be selected, and when the user is present in the area corresponding to the left side (the “left” side indicated by direction indicator 10) of display 106, a definition 4 may be selected.

Game device 100 may thus change correspondence between the user input to controller 200 and the aspect of the operation applicable to the operation object in accordance with the measured direction. In other words, game device 100 may maintain correspondence so long as controller 200 is measured as being present in the area corresponding to one side of display 106, and may change the correspondence when controller 200 is measured as being present in an area corresponding to another side of display 106. As interpretation of an intention of the user operation corresponding to the user input to controller 200 is changed in accordance with the measured direction, the user can perform an intuitive operation.

When correspondence is changed as a result of movement of controller 200, the display position and/or the orientation of the information presentation object may be changed prior thereto. Specifically, game device 100 may change the display position and/or the orientation of the information presentation object and thereafter change correspondence between the user input to controller 200 and the aspect of the operation applicable to the operation object.

As correspondence is changed after change in display position and/or orientation of the information presentation object, the user is implicitly notified that system 1 has recognized change in position of the user, and then interpretation of the user input to controller 200 is changed. Since the user can thus foresee change in interpretation of the user input, the user can keep performing the intuitive operation.

In another embodiment, at the same time or before the change in position and/or orientation of the information presentation object, correspondence between the user input to controller 200 and the of the operation applicable to the operation object may be changed in accordance with the measured direction.

Correspondence between the user input to controller 200 and the aspect of the operation applicable to the operation object refers to rules for determining which direction the user input (the input operation to press direction input portion 212 in the upward direction or the operation to swing controller 200) to controller 200 indicates in the screen shown on display 106. In other words, since relative relation between display 106 and controller 200 may change, the meaning of any user input to controller 200, that is, in which direction the operation object of interest should be moved in the shown screen, may be determined depending on a situation.

As shown in FIG. 14, for operation button 214, correspondence between the user input to controller 200 and the aspect of the operation applicable to the operation object may be maintained. In other words, for operation button 214 other than direction input portion 212 and acceleration sensor 206, correspondence does not have to be changed regardless of the measured direction of controller 200.

Though FIG. 14 shows the example in which aspects of the operation applicable to the operation object allocated to the plurality of directions (for example, the upward direction, the downward direction, the left direction, and the right direction) that can be inputted to direction input portion 212 are defined, interpretation of a direction of input to direction input portion 212 by game device 100 may be changed. Specifically, for example, game device 100 may change the meaning of the signal outputted from direction input portion 212 in accordance with the user operation.

For example, in the definition 1, when direction input portion 212 is pressed in the upward direction, the operation may be interpreted as the upward direction, and when direction input portion 212 is pressed in the downward direction, the operation may be interpreted as the downward direction, whereas in another definition 2, when direction input portion 212 is pressed in the upward direction, the operation may be interpreted as the left direction, and when direction input portion 212 is pressed in the downward direction, the operation may be interpreted as the right direction. In this case, correspondence between the interpreted operation direction (the upward direction, the downward direction, the left direction, and the right direction) and the direction of movement of the operation object may uniquely be determined. Consequently, correspondence between the operation input to controller 200 and an aspect of the operation applicable to the operation object is changed in accordance with the measured direction of controller 200.

Not only interpretation of the operation direction in a state that the operation onto direction input portion 212 has been completed (pressed state) but also interpretation of the operation direction in a process of operation onto direction input portion 212 may similarly be changed.

In yet another embodiment, an amount of correction in accordance with the position where controller 200 is present may be added for each position where controller 200 is present, and then a direction of input to direction input portion 212 may be interpreted. For example, when the signal outputted from direction input portion 212 in accordance with the user operation indicates an angle at which the user operation has been performed, four types of amounts of correction which are 0° (no correction), +90°, +180°, and +270° (or −90°) may be prepared as the amounts of correction. In this case, a corresponding amount of correction may be selected in accordance with the position where controller 200 is present, the signal outputted from direction input portion 212 may be corrected with the selected amount of correction, and then the input direction may be interpreted.

An example in which correspondence between the user input to controller 200 and the aspect of the operation applicable to the operation object is changed when controller 200 moves from an area corresponding to a certain side of display 106 to an area corresponding to another side thereof is shown in the present embodiment. In another embodiment, however, correspondence between the user input to controller 200 and the aspect of the operation applicable to the operation object may be changed even when controller 200 is present in the area corresponding to the same side of display 106. For example, in an example where the user (controller 200) is present on the left as facing display 106, when direction input portion 212 is pressed in the upward direction, it may indicate movement in an upper right direction on the screen, and in an example where the user is present on the right as facing display 106, when direction input portion 212 is pressed in the upward direction, it may indicate movement in an upper left direction on the screen.

In yet another embodiment, correspondence between the user input to controller 200 and the aspect of the operation applicable to the operation object does not have to be changed in accordance with the measured direction.

### [E. Display Position of Information Presentation Object]

The display position of the information presentation object may be changed in accordance with the measured direction as described above. At this time, the display position of the information presentation object may dynamically be determined in accordance with the measured direction, or may be selected as appropriate from among a plurality of predetermined positions.

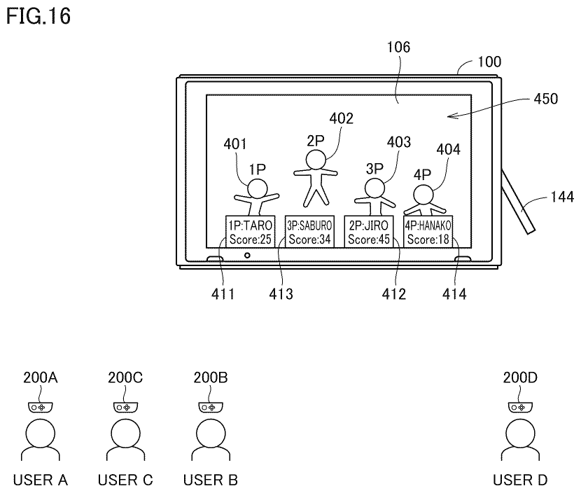

An exemplary screen on which the information presentation objects are shown at a plurality of predetermined positions in system 1 according to the present embodiment will be described with reference to FIG. 16. In the example shown in FIG. 16, directions in which four controllers 200 are present are measured, and four information presentation objects (information presentation objects 411 to 414) are shown in accordance with these measurement results, respectively.

The four information presentation objects may be shown at respective predetermined positions. In other words, four positions may be predetermined as positions where information presentation objects are to be shown. By determining in advance, positions where the information presentation objects are to be shown, such a situation as fluctuation of the display position of the information presentation object in accordance with the measured direction can be prevented, and hence lowering in viewability can be suppressed.

In display of the information presentation object at the predetermined position, the position where the information presentation object corresponding to each controller 200 is to be shown may be determined in accordance with relative positional relation between controllers 200 the directions of which have been measured.

Game device 100 may thus select the display position of the information presentation object in accordance with the measured direction, from among the plurality of positions predetermined as the display positions of the information presentation objects. Though FIG. 16 shows the example in which four information presentation objects 411 to 414 are shown at the four respective positions, in display of a smaller number of information presentation objects, positions as many as the information presentation objects to be shown may be selected from the four positions.

For example, in the example shown in FIG. 16, though the users A to C are present as being distant from the user D, information presentation objects 411 to 414 included in image 450 are arranged at an equal distance. Thus, in showing the information presentation objects for respective users, game device 100 allocates the display position of the information presentation object for each user from among the plurality of positions, in accordance with the direction of controller 200 associated with each user.

More specifically, game device 100 measures the directions in which the plurality of controllers 200 are present, respectively, estimates the order of arrangement of controllers 200 based on the measured directions, and determines the corresponding display position of the information presentation object for each controller 200 (user) in accordance with the estimated order of arrangement.

Even when the plurality of controllers 200 (users) are present, viewability from the plurality of users can be maintained by determination of the position where the information presentation object is to be shown based on the order of arrangement of controller 200.

When the display position of the information presentation object corresponding to the measured direction is different from the current display position of the information presentation object, the display position of the information presentation object may be changed to the display position corresponding to the measured direction after a predetermined condition is satisfied. Specifically, though the display position of the information presentation object may be changed each time the measured direction changes, a buffer time period to some extent may be provided. Such lowering in viewability as frequent change in display position of the information presentation object caused simply by movement of controller 200 from an original position only for a short period can thus be suppressed.

After the measured direction satisfies the condition for change in display position of the information presentation object and after the predetermined condition is satisfied, game device 100 may thus change the display position of the information presentation object. The condition for change in display position of the information presentation object includes a case in which a corresponding side of display 106 corresponding to the measured direction is different from a currently selected corresponding side of display 106 and a case where a plurality of controllers 200 correspond to the same side of display 106 and relative relation between the plurality of controllers 200 has changed.

Satisfaction of the predetermined condition may be determined based on lapse of a predetermined time period or on a motion or the like of controller 200, as will be described later.

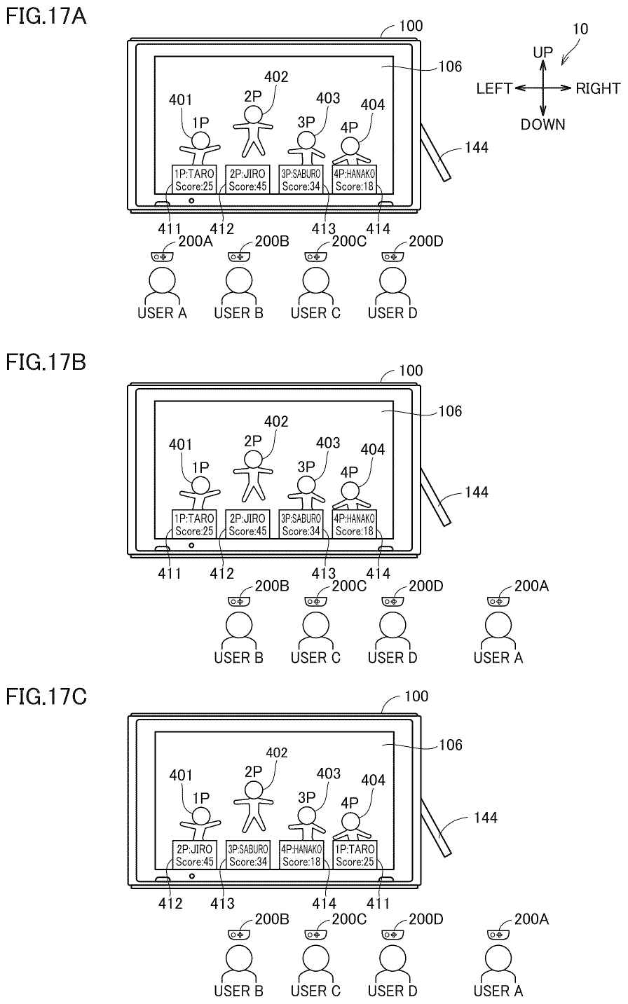

Exemplary processing for changing representation of the information presentation object in system 1 according to the present embodiment will be described with reference to FIGS. 17A to 17C. In the example shown in FIG. 17A, from the left as facing display 106, controller 200A, controller 200B, controller 200C, and controller 200D are present in this order, and in correspondence with this positional relation, information presentation object 411, information presentation object 412, information presentation object 413, and information presentation object 414 are shown on display 106 sequentially from the left.

For example, as shown in FIG. 17B, the user A who holds controller 200A is assumed to have moved to the right side (the “right” side indicated by direction indicator 10) of the user D who holds controller 200D. As relative relation between the user A (controller 200A) and the users B to D (controllers 200B to 200D) changes, the condition for change in display position of the information presentation object can be determined as being satisfied. In other words, in FIG. 17B, the display position of the information presentation object corresponding to the measured direction is different from the current display position of the information presentation object.

After the predetermined time period has elapsed since the state shown in FIG. 17B was set, the order of display of information presentation objects 411 to 414 is changed as shown in FIG. 17C. Specifically, from the left as facing display 106, controller 200B, controller 200C, controller 200D, and controller 200A are present in this order, and in correspondence with this positional relation, information presentation object 412, information presentation object 413, information presentation object 414, and information presentation object 411 are shown on display 106 sequentially from the left.

Though a state in which the user A is present, for example, between the user B and the user C can also be present in a process of movement of the user A, it is not reflected on change in position of the information presentation object unless the state lasts for a predetermined time period.

A time point of start of determination as to whether or not the state has lasted for a predetermined time period can freely be set. For example, determination may be started from the time point of start of change in position where controller 200A is present or from the time point of determination that controller 200A is present between controller 200B and controller 200C (that is, the time point of change in order of alignment of controllers 200).

A duration of the predetermined time period may be fixed or variable. When a variable value is adopted, it may dynamically be changed, for example, in accordance with a status of progress of a game or a frequency of a motion of controller 200.

In an example where three or more users play a game or an application, when the display positions of the information presentation objects are successively changed with change in positions of the users, viewability may lower. By thus providing the buffer time period to some extent, a state in which movement of the users has settled down can be reflected on the screen and lowering in viewability can be suppressed.

Instead of the time, another factor may be adopted as the condition for change in display position of the information presentation object. For example, accommodation within a predetermined range, of fluctuation (variation) over time in measurement value of the direction or the position where controller 200 is present may be adopted as the condition. In another embodiment, accommodation of the motion of controller 200 within a predetermined range (for example, controller 200 being regarded as being in a standstill) based on a detection value from acceleration sensor 206 (or a not-shown gyro sensor) of controller 200 may be adopted as the condition. In yet another embodiment, a plurality of conditions described above may be combined. The display position of the information presentation object may be changed, for example, when a certain state has lasted for a predetermined time period and controller 200 can be regarded as being in a standstill.

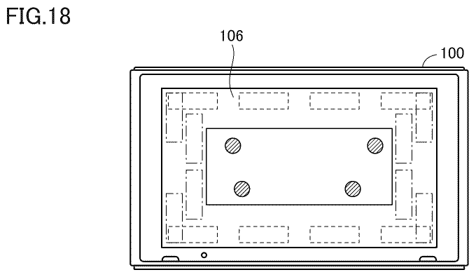

A plurality of exemplary predetermined positions where the information presentation objects are to be shown in system 1 according to the present embodiment will be described with reference to FIG. 18. In the example shown in FIG. 18, a plurality of positions (shown with a dashed line) where information presentation objects can be shown may be set in an image shown in the lay-flat mode.

In the example shown in FIG. 18, a plurality of positions are predetermined for each side of display 106, and the information presentation object can be shown for each user (controller 200) even when a plurality of users (controllers 200) are present in an area corresponding to the same side.

In another embodiment, only a region where the information presentation object is to be shown may be set. For example, in the example shown in FIG. 18, the position of the information presentation object may freely be set in accordance with the position where controller 200 is present, so long as the position is located on a screen end side of each side. Alternatively, in yet another embodiment, the information presentation object may be shown at any position in the screen.

### [F. Display Position and Orientation of Operation Object]

The example in which the display position and the orientation of the operation object included in the image shown on display 106 do not change depending on the direction in which controller 200 is present is shown in the description above.

Specifically, game device 100 may maintain the display position and the orientation of the operation object independently of the measured direction. As the display position and the orientation of the operation object are maintained, in play of a game or an application by a plurality of users, the possibility of an uncomfortable or disoriented feeling felt by the users can be eliminated.

In another embodiment, in accordance with the direction in which controller 200 is present, only the orientation of the operation object may be changed with the display position thereof being maintained. Viewability from the user can be improved by changing only the orientation of the operation object depending on a situation.

In yet another embodiment, an operation to move the operation object and/or an operation to change the orientation of the operation object may be performed in accordance with the direction in which controller 200 is present.

### [G. Processing Procedure]

An exemplary procedure of processing performed by system 1 according to the present embodiment will now be described.

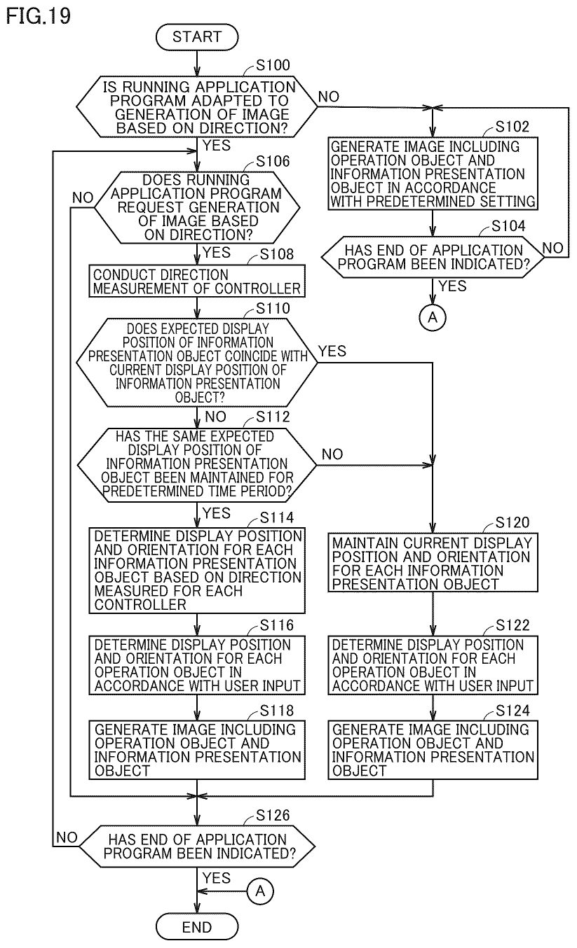

An exemplary procedure of processing performed by game device 100 in system 1 according to the present embodiment will be described with reference to FIG. 19. Each step shown in FIG. 19 is typically performed by execution of application program 112 by processor 102 of game device 100.

Game device 100 determines whether or not running application program 112 is configured to generate the image based on the direction (step S100). When the game device is not configured to generate the image based on the direction (NO in step S100), game device 100 does not conduct direction measurement of controller 200 but generates the image including the operation object and the information presentation object in accordance with predetermined setting (step S102). The generated image is outputted to display 106.

Game device 100 determines whether or not end of the application program has been indicated (step S104). When end of the application program has not been indicated (NO in step S104), processing in step S102 or later is repeated. When end of the application program has been indicated (YES in step S104), the process ends.

When the game device is configured to generate the image based on the direction (YES in step S100), game device 100 determines whether or not running application program 112 requests generation of the image based on the direction (step S106). When running application program 112 does not request generation of the image based on the direction (NO in step S106), processing in step S126 or later is performed.

When running application program 112 requests generation of the image based on the direction (YES in step S106), game device 100 conducts direction measurement of controller 200 (step S108). Game device 100 then determines whether or not the position where the information presentation object is to be shown (which is also referred to as an “expected display position of the information presentation object” below) in correspondence with the measured direction is different from the current display position of the information presentation object (step S110). In other words, game device 100 determines whether or not the position where the information presentation object is to be shown, the position being determined based on the measured direction, coincides with the position where the information presentation object is currently shown.

When the expected display position of the information presentation object does not coincide with the current display position of the information presentation object (NO in step S110), game device 100 determines whether or not the same expected display position of the information presentation object has been maintained for a predetermined time period (step S112).

When the same expected display position of the information presentation object has been maintained for the predetermined time period (YES in step S112), game device 100 determines the display position and the orientation for each information presentation object based on the direction measured for each controller 200 (step S114) and determines the display position and the orientation for each operation object in accordance with the user input (step S116). The game device then generates an image including the operation object and the information presentation object (step S118). The generated image is outputted to display 106. Processing in step S126 or later is then performed.

When the expected display position of the information presentation object coincides with the current display position of the information presentation object (YES in step S110), game device 100 maintains the current display position and orientation for each information presentation object (step S120) and determines the display position and the orientation for each operation object in accordance with the user input (step S122). The game device then generates an image including the operation object and the information presentation object (step S124). The generated image is outputted to display 106. Processing in step S126 or later is then performed.

When the same expected display position of the information presentation object has not been maintained for the predetermined time period (NO in step S112), processing in step S120 or later is performed.

Game device 100 determines whether or not the end of the application program has been indicated (step S126). When the end of the application program has not been indicated (NO in step S126), processing in step S106 or later is repeated. When the end of the application program has been indicated (YES in step S126), the process ends.

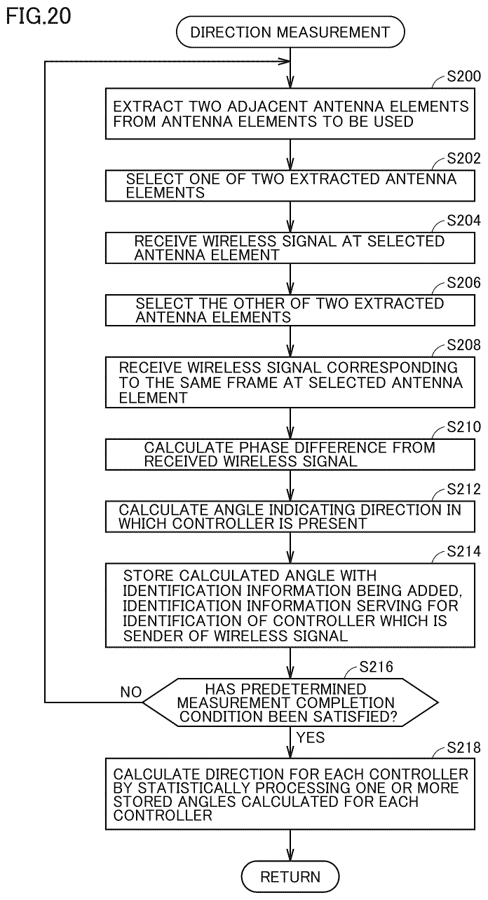

An exemplary procedure of processing in direction measurement shown in FIG. 19 will be described with reference to FIG. 20. Game device 100 extracts two adjacent antenna elements 125 among antenna elements 125 to be used (step S200). Game device 100 selects one of two extracted antenna elements 125 (step S202) and receives the wireless signal at selected antenna element 125 (step S204). In succession, game device 100 selects the other of two extracted antenna elements 125 (step S206) and receives the wireless signal corresponding to the same frame at selected antenna element 125 (step S208).

Game device 100 then calculates the phase difference between the wireless signal received in step S204 and the wireless signal received in step S208 (step S210) and calculates an angle indicating the direction in which controller 200 is present based on the calculated phase difference (step S212). Furthermore, game device 100 adds to the angle, identification information for identifying controller 200 which is the sender of the wireless signal received at two antenna elements 125, and has the calculated angle stored (step S214).

Game device 100 determines whether or not a predetermined measurement completion condition has been satisfied (step S216). The predetermined measurement completion condition includes such a condition as measurement over a predetermined time period and a predetermined number of times of measurement.

When the predetermined measurement completion condition has not been satisfied (NO in step S216), processing in step S200 or later is repeated.

When the predetermined measurement completion condition has been satisfied (YES in step S216), game device 100 calculates the direction for each controller 200 by statistically processing one or more stored angles calculated for each controller 200 (step S218). The process then returns.

### [H. Other Forms]

Allocation of various types of processing to entities is not limited as described above. For example, processor 102 of game device 100 may be responsible for processing for generating an image, or a computing resource other than game device 100 may be used therefor. Typically, a computing resource on a cloud that can communicate with game device 100 may generate the image. In this case, game device 100 transmits a signal indicating the user operation received from controller 200 and information indicating the direction of controller 200 to the computing resource, and receives the image from the computing resource and outputs the image to display 106 or an external display. Furthermore, rather than the computing resource on the cloud, any computing resource that can communicate over a local network may be used.

Though the example in which the direction of controller 200 is measured with the use of the wireless signal transmitted from controller 200 is described above, the direction may be measured with another method. For example, infrared rays or ultrasound may be used.

Rather than the configuration in which game device 100 receives the wireless signal transmitted from controller 200 and measures the direction, a configuration in which controller 200 receives the wireless signal transmitted from game device 100 and measures the direction may be adopted. In this case, by transmission of information indicating the direction measured by controller 200 to game device 100, information on the direction can be reflected on generation of the image.

Though the example in which the position and the orientation of the game screen itself as the entirety to be shown on display 106 are not changed in accordance with the direction in which controller 200 is present is described above, in another embodiment, the position and the orientation thereof may be changed. For example, when two users (two controllers 200) are present with game device 100 in the lay-flat mode lying therebetween, a game screen may be shown as being turned with progress of a game. By way of example, the game screen itself (which may be a substantial game screen, with various interface representations or the like surrounding the game screen, for example, being excluded) may be shown, for example, as being vertically inverted by turning such that a user in his/her turn readily performs an operation in accordance with the order (turn) of operation by each user. Alternatively, when users (four controllers 200) are present in four directions around game device 100, the game screen may be shown as being turned in the four directions. When the game screen includes the information presentation object, the information presentation object may be shown as being turned together with the game screen without change in relative position and attitude of the information presentation object with respect to the game screen, or the relative position and the attitude of the information presentation object with respect to the game screen may be changed in accordance with rotational representation of the game screen.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A system comprising:
a display; and
one or more memories configured to store instructions that, when executed, cause one or more processors to perform operations comprising:
obtaining a direction in which a controller is present with respect to the display,
showing on the display an image comprising a first object and a second object, the first object being movable within the image in accordance with user input to the controller, the second object presenting information about a user who operates the controller and/or the first object, and
responsive to the direction in which the controller is present with respect to the display moving from a first direction to a second direction, changing a display position and/or an orientation of the second object in the image in accordance with the move from the first direction to the second direction, without also moving the first object in the image.

2. The system according to claim 1, wherein responsive to the detected change to the direction in which the controller is present with respect to the display, a correspondence between the user input to the controller and an aspect of an operation applicable to the first object is changed.

3. The system according to claim 2, wherein:
the controller comprises a direction input portion, and
the correspondence that is changed is a correspondence between a direction inputted to the direction input portion and a direction of movement of the first object on the display.

4. The system according to claim 2, wherein
the controller comprises a sensor configured to detect motion of the controller, and
the correspondence that is changed is the correspondence between a direction of the detected motion and a direction of movement of the first object on the display.

5. The system according to claim 2, wherein
the display is rectangular,
the correspondence is maintained so long as the controller is determined to be present in an area corresponding to one side of the display, and
the correspondence is changed when the controller is determined to be present in another area corresponding to another side of the display.

6. The system according to claim 2, wherein the correspondence is changed after the changing of the display position and/or the orientation of the second object.

7. The system according to claim 1, wherein a display position of the second object is selected from among a plurality of predefined display positions for the second object in accordance with the direction after the detected change.

8. The system according to claim 7, wherein each of a plurality of second objects is associated with a respective user using the system, each display position for each second objects being selected from the plurality of predefined display positions in accordance with a direction of a controller of the associated user.

9. The system according to claim 7, wherein when the selected display position of the second object is different from a current display position of the second object, the display position of the second object is changed from the current display position to the selected display position after a condition is satisfied.

10. The system according to claim 9, wherein the condition is satisfied when a predetermined time period elapses.

11. The system according to claim 9, wherein when second objects are shown for three or more users, display positions of the second objects are rearrangeable from current positions to newly selected positions in accordance with the obtained directions such that second objects adjacent to one in their current positions will not necessarily be adjacent to one another in their newly selected positions.

12. The system according to claim 1, wherein the first object does not change orientation based on the detected change to the direction in which the controller is present with respect to the display.

13. A processing method comprising:
obtaining a direction in which a controller is present with respect to a display;
showing on the display an image comprising a first object and a second object, the first object being movable within the image in accordance with user input to the controller, the second object presenting information about a user who operates the controller and/or the first object; and
responsive to the direction in which the controller is present with respect to the display moving from a first direction to a second direction, changing a display position and/or an orientation of the second object in accordance with the move from the first direction to the second direction, without also moving the first object in the image.

14. The processing method according to claim 13, further comprising changing a correspondence between the user input to the controller and an aspect of an operation applicable to the first object, responsive to the detected change to the direction in which the controller is present with respect to the display,
wherein the controller comprises a direction input portion, and
wherein the correspondence that is changed is a correspondence between a direction inputted to the direction input portion and a direction of movement of the first object on the display.

15. The processing method according to claim 13, further comprising changing a correspondence between the user input to the controller and an aspect of an operation applicable to the first object, responsive to the detected change to the direction in which the controller is present with respect to the display,
wherein the controller comprises a sensor configured to detect motion of the controller, and
wherein the correspondence that is changed is the correspondence between a direction of the detected motion and a direction of movement of the first object on the display.

16. The processing method according to claim 13, further comprising changing a correspondence between the user input to the controller and an aspect of an operation applicable to the first object, responsive to the detected change to the direction in which the controller is present with respect to the display,
wherein the display is rectangular,
the correspondence is maintained so long as the controller is determined to be present in an area corresponding to one side of the display, and
wherein the correspondence is changed when the controller is determined to be present in another area corresponding to another side of the display.

17. A non-transitory computer-readable storage medium having instructions stored thereon which, when executed, cause one or more processors to perform operations comprising:
obtaining a direction in which a controller is present with respect to a display;
showing on the display an image comprising a first object and a second object, the first object being movable within the image in accordance with user input to the controller, the second object presenting information about a user who operates the controller and/or the first object; and
responsive to the direction in which the controller is present with respect to the display moving from a first direction to a second direction, changing a display position and/or an orientation of the second object in accordance with the move from the first direction to the second direction, without also moving the first object in the image.

18. The non-transitory computer-readable storage medium according to claim 17, wherein:
responsive to the detected change to the direction in which the controller is present with respect to the display, a correspondence between the user input to the controller and an aspect of an operation applicable to the first object is changed,
the controller comprises a direction input portion, and
the correspondence that is changed is a correspondence between a direction inputted to the direction input portion and a direction of movement of the first object on the display.

19. The non-transitory computer-readable storage medium according to claim 17, wherein:
responsive to the detected change to the direction in which the controller is present with respect to the display, a correspondence between the user input to the controller and an aspect of an operation applicable to the first object is changed,
the controller comprises a sensor configured to detect motion of the controller, and
the correspondence that is changed is the correspondence between a direction of the detected motion and a direction of movement of the first object on the display.

20. The non-transitory computer-readable storage medium according to claim 17, wherein:
responsive to the detected change to the direction in which the controller is present with respect to the display, a correspondence between the user input to the controller and an aspect of an operation applicable to the first object is changed,
the display is rectangular,
the correspondence is maintained so long as the controller is determined to be present in an area corresponding to one side of the display, and
the correspondence is changed when the controller is determined to be present in another area corresponding to another side of the display.
